(19) United States
(12) Patent Application Publication
(10) Pub. No.: US 2011/0296466 A1
(43) Pub. Date: Dec. 1, 2011

(54) SYSTEM AND METHOD FOR MULTI-NETWORK PROGRAM RETRIEVAL

(75) Inventors: Hong Nguyen, Atlanta, GA (US); MICHAEL DENNY, Sharpsburg, GA (US)

(73) Assignee: AT&T INTELLECTUAL PROPERTY I, L. P., RENO, NV (US)

(21) Appl. No.: 12/789,423

(22) Filed: May 27, 2010

(51) Int. Cl. H04N 5/445

(52) U.S. Cl. 725/55

(57) ABSTRACT

A system that incorporates teachings of the present disclosure may include, for example, network device having a controller programmed to transmit requests on a primary network for a program recording corresponding to a program on at least one of the plurality of Electronic Program Guides (EPGs) where the EPGs are retrieved from a plurality of network sources including a plurality of remote network sources unaffiliated with the primary network and receive the requested program recording. Other embodiments are disclosed.

### FIELD OF THE DISCLOSURE

The present disclosure relates generally to communication systems and more specifically to a method and apparatus for multi-network program retrieval.

### BACKGROUND

Interactive TV networks provide a multitude of services including broadcast programming and video-on-demand. These networks reach out to users in various environments including single family residences, multi-dwelling apartments and commercial facilities and each may have their own disparate Electronic Program Guides or EPGs. The types of service and the ability to provide those services is often dependent on the particular environment of the potential users.

### BRIEF DESCRIPTION OF THE DRAWINGS

FIGS. 1, 4, and 5 depict illustrative embodiments of communication systems that provide program retrieval services;

FIG. 2 depicts an illustrative embodiment of a portal interacting with the communication system of FIG. 1;

FIG. 3 depicts an illustrative embodiment of a communication device utilized in the communication system of FIG. 1;

FIG. 6 depicts an illustrative embodiment of a method operating in portions of the communications systems of FIGS. 1, 4 and 5;

FIG. 7 is a diagrammatic representation of a machine in the form of a computer system within which a set of instructions, when executed, may cause the machine to perform any one or more of the methodologies discussed herein.

### DETAILED DESCRIPTION

One embodiment of the present disclosure can entail a non-transitory computer readable storage medium comprising computer instructions to retrieve a plurality of Electronic Program Guides (EPGs) from a plurality of network sources, receive requests from a communication device for a program recording corresponding to a program on at least one of the plurality of EPGs, receive the requested program recording, and transmit the requested program recording to the communication device.

Another embodiment of the present disclosure can entail a method comprising retrieving a plurality of EPGs from a plurality of remote network sources unaffiliated with the primary service provider, receiving requests from a set top box for a program recording corresponding to a program on at least one of the plurality of EPGs, receiving the requested program recording, and transmitting the requested program recording to the communication device requesting the program recording.

Yet another embodiment of the present disclosure can entail a network device comprising a controller programmed to transmit requests on a primary network for a program recording corresponding to a program on at least one of the plurality of Electronic Program Guides (EPGs) where the EPGs are retrieved from a plurality of network sources including a plurality of remote network sources unaffiliated with the primary network and receive the requested program recording

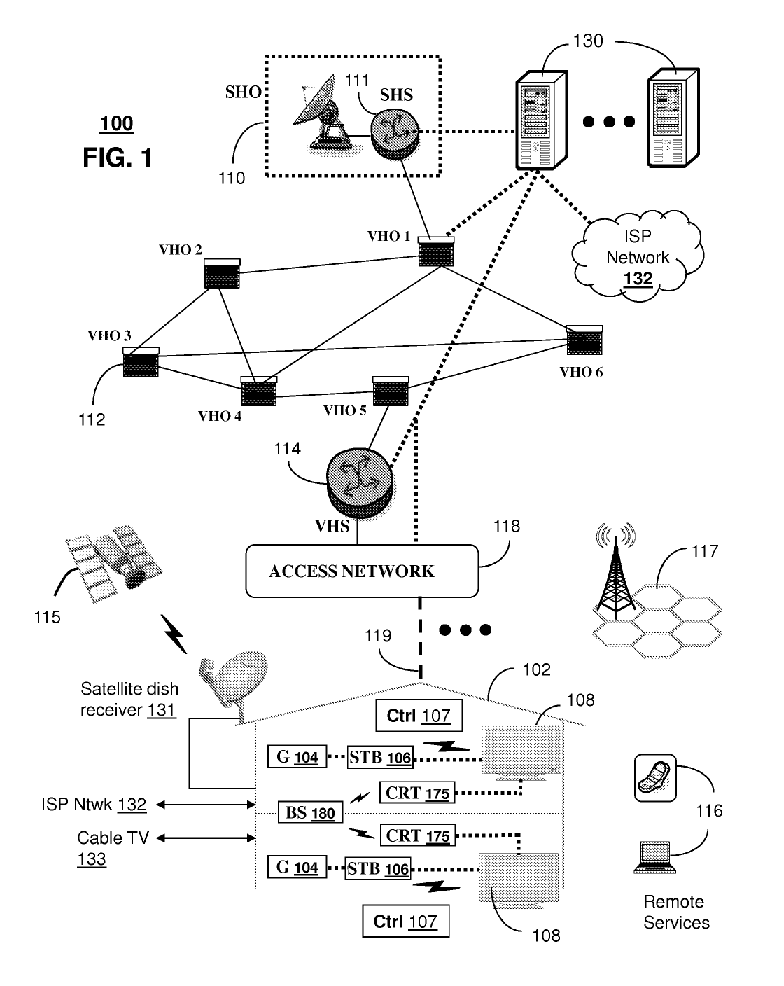

FIG. 1 depicts an illustrative embodiment of a first communication system 100 for delivering media content. The communication system 100 can represent an Internet Protocol Television (IPTV) broadcast media system. The IPTV media system can include a super head-end office (SHO) 110 with at least one super headend office server (SHS) 111 which receives media content from satellite and/or terrestrial communication systems. In the present context, media content can represent audio content, moving image content such as videos, still image content, or combinations thereof. The SHS server 111 can forward packets associated with the media content to video head-end servers (VHS) 114 via a network of video head-end offices (VHO) 112 according to a common multicast communication protocol.

The VHS 114 can distribute multimedia broadcast programs via an access network 118 to commercial and/or residential buildings 102 housing a gateway 104 (such as a common residential or commercial gateway). The building 102 can be various types including multi-dwelling units which house a plurality of different subscribers. The access network 118 can represent a group of digital subscriber line access multiplexers (DSLAMs) located in a central office or a service area interface that provide broadband services over optical links or copper twisted pairs 119 to buildings 102. The gateway 104 can use common communication technology to distribute broadcast signals to media processors 106 such as Set-Top Boxes (STBs) which in turn present broadcast channels to media devices 108 such as computers or television sets managed in some instances by a media controller 107 (such as an infrared or RF remote control).

The gateway 104, the media processors 106, and media devices 108 can utilize tethered interface technologies (such as coaxial or phone line wiring) or can operate over a common wireless access protocol. With these interfaces, unicast communications can be invoked between the media processors 106 and subsystems of the IPTV media system for services such as video-on-demand (VoD), browsing an electronic programming guide (EPG), or other infrastructure services.

Some of the network elements of the IPTV media system can be coupled to one or more computing devices 130 a portion of which can operate as a web server for providing portal services over an Internet Service Provider (ISP) network 132 to wireline media devices 108 or wireless communication devices 116 by way of a wireless access base station 117 operating according to common wireless access protocols such as Wireless Fidelity (WiFi), or cellular communication technologies (such as GSM, CDMA, UMTS, WiMAX, Software Defined Radio or SDR, and so on).

Another distinct portion of the computing devices 130 can function as a server (herein referred to as server 130). The server 130 can use common computing and communication technology to perform the function of relaying and/or receiving media content to ISP network 132 or to other networks.

It will be appreciated by an artisan of ordinary skill in the art that a satellite broadcast television system can be used in place of the IPTV media system. In this embodiment, signals transmitted by a satellite 115 supplying media content can be intercepted by a common satellite dish receiver 131 coupled to the building 102. Modulated signals intercepted by the satellite dish receiver 131 can be submitted to the media processors 106 for generating broadcast channels which can be presented at the media devices 108. The media processors 106 can be equipped with a broadband port to the ISP network 132 to enable infrastructure services such as VoD and EPG described above.

In yet another embodiment, an analog or digital broadcast distribution system such as cable TV system 133 can be used in place of the IPTV media system described above. In this embodiment the cable TV system 133 can provide Internet, telephony, and interactive media services.

In one embodiment, the building 102 can have a surveillance system 150 including various security devices such as security cameras, motion detectors, automated door locks, intercoms, processors and so forth. Each of the units and/or subscribers within the building 102 can have a cognitive radio transceiver (CRT) 175 that can wirelessly receive signals from the surveillance system 150. The signals can be video media captured by security cameras throughout the building (such as at the front door, the pool, and so forth).

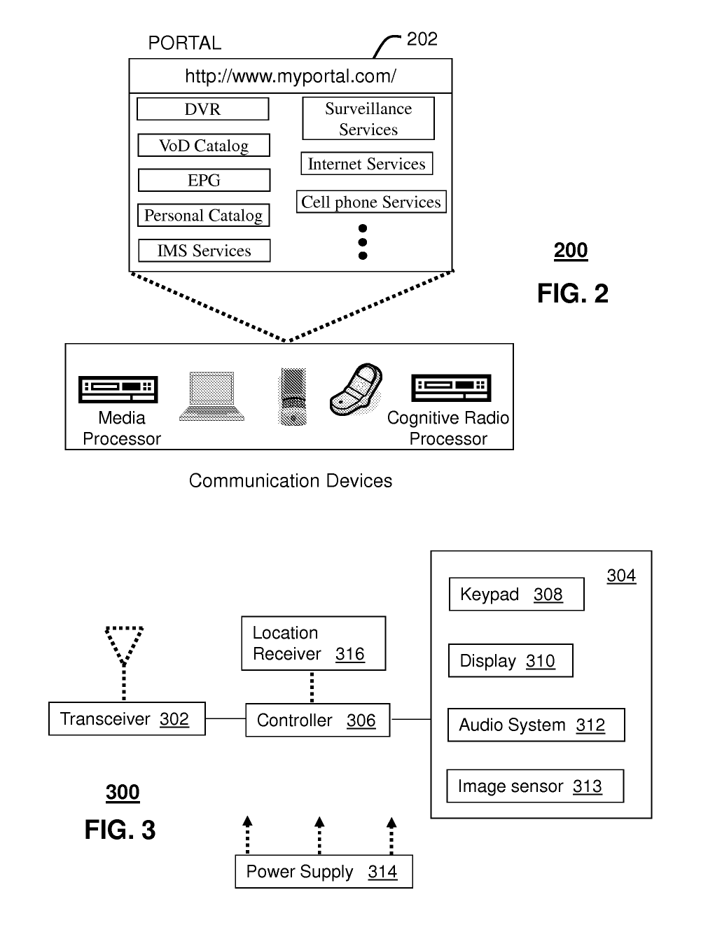

FIG. 2 depicts an illustrative embodiment of a portal 202 which can operate from the computing devices 130 described earlier of communication system 100 illustrated in FIG. 1. The portal 202 can be used for managing services of communication system 100. The portal 202 can be accessed by a Uniform Resource Locator (URL) with a common Internet browser such as Microsoft's Internet Explorer™ using an Internet-capable communication device such as those described for FIG. 1. The portal 202 can be configured, for example, to access a media processor 106 and services managed thereby such as a Digital Video Recorder (DVR), a VoD catalog, an EPG, a personal catalog (such as personal videos, pictures, audio recordings, etc.) stored in the media processor, provisioning IMS services, provisioning Internet services, provisioning cellular phone services, provisioning surveillance services and so on. For example, a user can utilize the portal to configure the cognitive radio processor for receiving video security footage as it is captured by security cameras in the building. In another embodiment, the captured video can be forwarded to other communication devices and/or entities, such as a mobile telephone of the user or the police.

FIG. 3 depicts an exemplary embodiment of a communication device 300. Communication device 300 can serve in whole or in part as an illustrative embodiment of the communication devices of FIG. 1. The communication device 300 can comprise a wireline and/or wireless transceiver 302 (herein transceiver 302), a user interface (UI) 304, a power supply 314, a location receiver 316, and a controller 306 for managing operations thereof. The transceiver 302 can support short-range or long-range wireless access technologies such as Bluetooth, WiFi, Digital Enhanced Cordless Telecommunications (DECT), or cellular communication technologies, just to mention a few. Cellular technologies can include, for example, CDMA-1×, UMTS/HSDPA, GSM/GPRS, TDMA/EDGE, EV/DO, WiMAX, SDR, and next generation cellular wireless communication technologies as they arise. The transceiver 302 can also be adapted to support circuit-switched wireline access technologies (such as PSTN), packet-switched wireline access technologies (such as TCPIP, VoIP, etc.), and combinations thereof.

The UI 304 can include a depressible or touch-sensitive keypad 308 with a navigation mechanism such as a roller ball, joystick, mouse, or navigation disk for manipulating operations of the communication device 300. The keypad 308 can be an integral part of a housing assembly of the communication device 300 or an independent device operably coupled thereto by a tethered wireline interface (such as a USB cable) or a wireless interface supporting for example Bluetooth. The keypad 308 can represent a numeric dialing keypad commonly used by phones, and/or a Qwerty keypad with alphanumeric keys. The UI 304 can further include a display 310 such as monochrome or color LCD (Liquid Crystal Display), OLED (Organic Light Emitting Diode) or other suitable display technology for conveying images to an end user of the communication device 300. In an embodiment where the display 310 is touch-sensitive, a portion or all of the keypad 308 can be presented by way of the display.

The UI 304 can also include an audio system 312 that utilizes common audio technology for conveying low volume audio (such as audio heard only in the proximity of a human ear) and high volume audio (such as speakerphone for hands free operation). The audio system 312 can further include a microphone for receiving audible signals of an end user. The audio system 312 can also be used for voice recognition applications. The UI 304 can further include an image sensor 313 such as a charged coupled device (CCD) camera for capturing still or moving images.

The power supply 314 can utilize common power management technologies such as replaceable and rechargeable batteries, supply regulation technologies, and charging system technologies for supplying energy to the components of the communication device 300 to facilitate long-range or short-range portable applications. The location receiver 316 can utilize common location technology such as a global positioning system (GPS) receiver for identifying a location of the communication device 300 based on signals generated by a constellation of GPS satellites, thereby facilitating common location services such as navigation.

The communication device 300 can use the transceiver 302 to also determine a proximity to a cellular, WiFi or Bluetooth access point by common power sensing techniques such as utilizing a received signal strength indicator (RSSI) and/or a signal time of arrival (TOA) or time of flight (TOF). The controller 306 can utilize computing technologies such as a microprocessor, a digital signal processor (DSP), and/or a video processor with associated storage memory such a Flash, ROM, RAM, SRAM, DRAM or other storage technologies.

The communication device 300 can be adapted to perform the functions of the media processor 106, the media devices 108, or the portable communication devices 116 of FIG. 1. It will be appreciated that the communication device 300 can also represent other common devices that can operate in communication system 100 of FIG. 1 such as a gaming console and a media player.

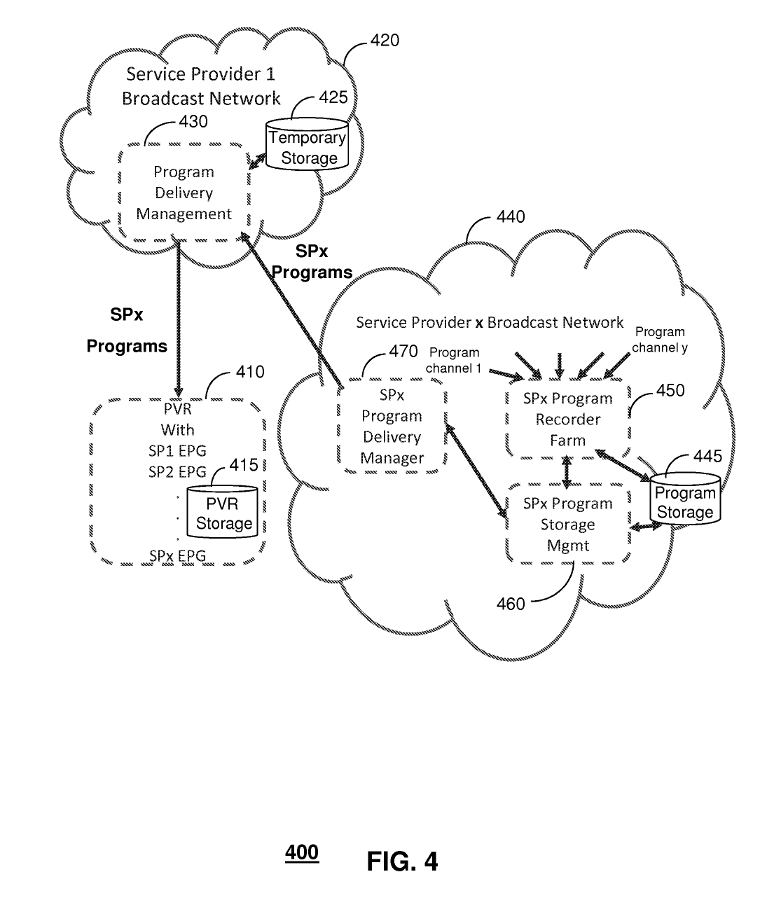

FIG. 4 depicts an illustrative embodiment of a system 400 for providing multi-network access and retrieval of programming to a plurality of users, the system 400 being operable in portions of the communications system of FIG. 1, 4 or 5. In one embodiment, the system 400 serves as a Global IPTV program Network enabling an IPTV set top box (STB) user to request a recording of a cable program and/or IPTV program or other network program being offered by a remote operator, especially operators in another country. The user can use a Person Video Receiver (PVR) STB device to browse EPGs for programs being offered by remote service providers and not just from the primary service provider. The user then can select and request a recording of any program from the remote provider's EPG and have it sent to the user's PVR device for later viewing.

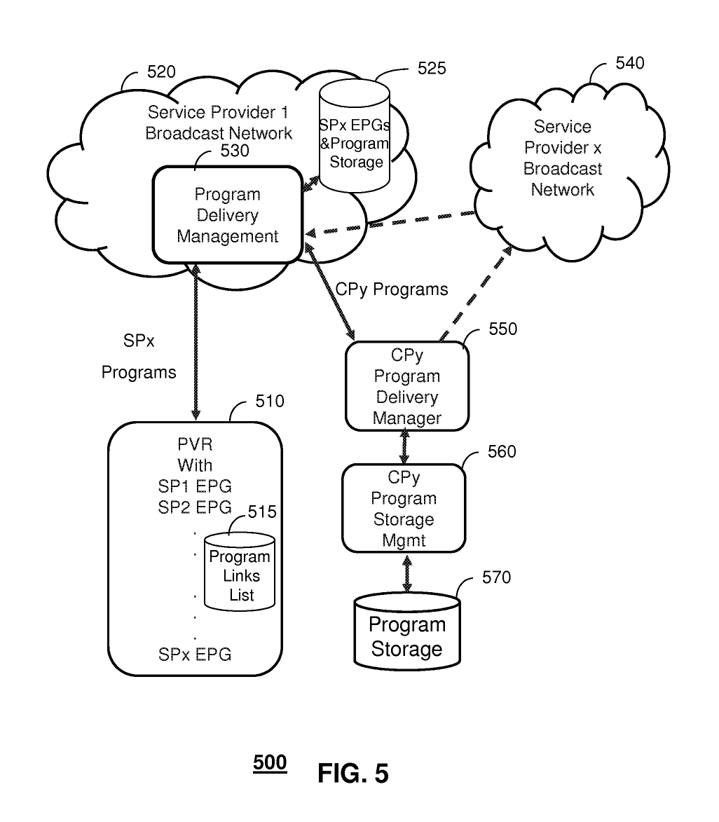

More specifically, the system 400 can include a PVR 410 with a plurality of EPGs for a plurality of service providers. The PVR can also include storage or memory space 415 for storing the plurality of EPGs and the received programs. The PVR 410 would be in communication with a primary service provider or broadcast network 420 also having storage or memory space 425 for EPGs and/or programs either available from the network 420 or other unaffiliated networks such as network 440 which corresponds to “Service Provider X's broadcast network”. Although a single unaffiliated or secondary service provider X (SPx) network is illustrated for simplicity, it should be understood that such a system 400 can include many SPx networks. Each service provider (SPx) can have their own program storage 445, program recorder farm 450, program storage management module 460 as well as a program delivery manager 470 as illustrated in FIG. 4. The service provider may have its own content, but the SPx may also have one or more external content providers (CPy) as illustrated in FIG. 5. The content is arranged in a plurality of channels and timeslots and a corresponding EPG for the particular SPx can be generated.

In such as system, program delivery requests are supported by SPx and the plurality of SPxs would provide the primary service provider 420 with their corresponding EPGs and the primary service provider 420 would provide the PVR 410 with either the plurality of EPGs or an aggregation of the EPGs. The PVR (or STB) 410 would make a EPG program request to the primary service provider 420 through a program request aggregator and control module or the program delivery management module 430 to the SPx program delivery manager module 470. In response, the module 470 can make a program delivery from the SPx program delivery manager module 470 to the program delivery management module 430 to the PVR 410. In the process, requested programs can be buffered or stored corresponding storage 445, 425, and/or 415.

The architecture described above allows a user to view recordings of programs that were offered by external cable/IPTV operators, including providers in other nations. This arrangement is of great interest to foreign speaking individuals who wish to view programs in their native languages, for example. Typical existing systems have PVR capability that is limited to the primary provider's program listing since there is minimal collaboration with remote service providers.

Referring to FIG. 5, a similar communication system 500 to system 400 of FIG. 4 illustrates that the plurality of service providers (SPx) can be supported by one or more content providers (CPy). The content providers can support the SPx and/or directly support the primary service providers. The system 500 can include a PVR 510 with a plurality of EPGs for a plurality of service providers. The PVR can also include storage or memory space (not shown) for storing the plurality of EPGs and the received programs or it can have a virtual storage by means of a program links list 515. The PVR 510 would be in communication with a primary service provider or broadcast network 520 also having storage or memory space 525 for EPGs and/or programs either available from the network 520 or other unaffiliated networks such as network 540 which corresponds to “Service Provider X's broadcast network”. The primary service provider broadcast network 520 can also alternatively be in direct communication with a number of content providers CPy each having their own program delivery manager 550, program storage management 560 and program storage 570. Although a single unaffiliated or secondary service provider X (SPx) network and a single content provider y (CPy) is illustrated for simplicity, it should be understood that such a system 500 can include many SPx networks and content providers CPy. Each service provider (SPx) can have their own program storage 445, program recorder farm 450, program storage management module 460 as well as a program delivery manager 470 as illustrated in FIG. 4.

Note that with content provided by CPys directly to the primary service provider 520 or through SPxs 540, the primary service provider will likely have some form of EPG aggregation and/or modification process before submitting EPGs and/or content to the PVR 510. Further note that SPx program requests and program deliveries can be made through the primary service provider 520 and directly with a content service provider. As discussed above, the PVR 510 can support virtual storage and use a program links list 515 having links or pointers that can point to programs store either any of the SPxs or the CPys.

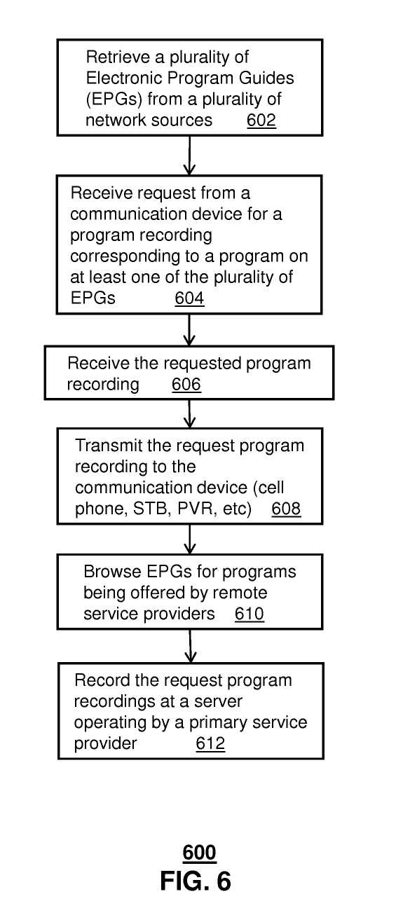

FIG. 6 depicts an illustrative method 600 that operates in portions of the communication systems of FIGS. 1, 4, and 5. Method 600 can begin with step 602 in which the method retrieves at 602 a plurality of EPGs from a plurality of remote network sources unaffiliated with the primary service provider and receives at 604 requests from a set top box or PVR or other communication device for a program recording corresponding to a program on at least one of the plurality of EPGs. The method at 606 can receive the requested program recording and transmit at 608 the requested program recording to the communication device (or cell phone, STB, PVR or other device) requesting the program recording. The method can optionally browse or search EPGs for programs being offered by remote service providers at 610. The programs on the various EPGs can be aggregated or modified as necessary depending on the network configurations and collaboration agreements that may be in place in such a system. At 610, the requested program recordings can be recorded at a server at the primary service provider. Note that the communication device can be any mobile device associated with the user of the STB or PVR including cell phones or remotes for example. The communication device can be the STB, a PVR or a STB with PVR functionality. In addition to collecting EPG information from the plurality of network sources, the system can publish the EPG information to a user's set top box wherein the plurality of network sources include a plurality of remote networks unaffiliated with a current provider network.

Upon reviewing the aforementioned embodiments, it would be evident to an artisan with ordinary skill in the art that said embodiments can be modified, reduced, or enhanced without departing from the scope and spirit of the claims described below. For example, such a system and method can entail in particular embodiment a PVR STB which can support browsing of multiple EPG's from remote providers and send customer requests for program recordings to a primary service provider where the recorded programs are received at the PVR STB from the primary service provider for subsequent viewing. In another aspect, the embodiments can also entail an inter-service provider collaboration network for collecting EPG information from remote service providers and publishing the EPG information to the user's PVR, and transmitting and receiving recorded programs. Such a system can include primary service provider recording servers for recording EPG channel programs. To a primary service provider, such an arrangement can provide a great revenue base as well as a means for better customer retention. The requested programs can be provided similar to Video on Demand programming or can be a pay-per-program-recording that is based on a usage approach. For a foreign national for example, this can provide the benefit of viewing their favorite TV programs in their native language and programming while visiting a foreign country.

Other suitable modifications can be applied to the present disclosure without departing from the scope of the claims below. Accordingly, the reader is directed to the claims section for a fuller understanding of the breadth and scope of the present disclosure.

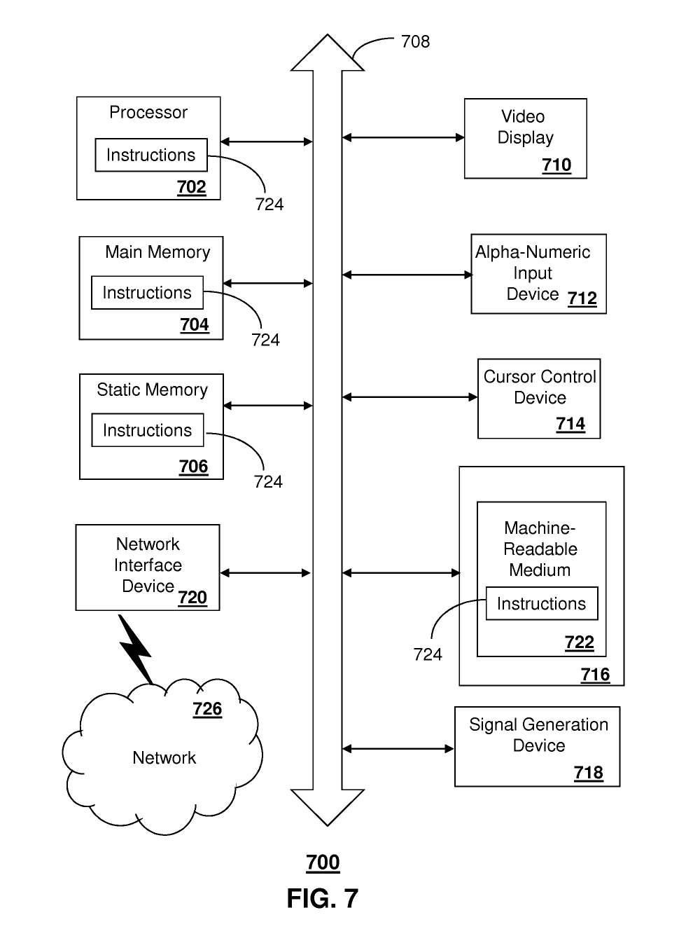

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A non-transitory computer readable storage medium comprising computer instructions to:
retrieve a plurality of Electronic Program Guides (EPGs) from a plurality of network sources;
receive requests from a communication device for a program recording corresponding to a program on at least one of the plurality of EPGs;
receive the requested program recording; and
transmit the requested program recording to the communication device.

2. The storage medium of claim 1, wherein the communication device is a mobile device associated with a user of a set top box (STB) or a personal video recorder (PVR).

3. The storage medium of claim 1, wherein the communication device is a set top box or a personal video recorder.

4. The storage medium of claim 1, wherein the communication device is a cellular phone.

5. The storage medium of claim 1, wherein the communication device is a set top box and the storage medium comprises computer instructions to browse electronic program guides for programs being offered by a remote service providers

6. The storage medium of claim 1, comprising computer instructions for collecting EPG information from the plurality of network sources and publishing the EPG information to a user's set top box wherein the plurality of network sources include a plurality of remote networks unaffiliated with a current provider network.

7. The storage medium of claim 1, comprising computer instructions to record the requested program recordings at a server operated by a primary service provider.

8. A method at a server at a primary service provider, comprising:
retrieving a plurality of Electronic Program Guides (EPGs) from a plurality of remote network sources unaffiliated with the primary service provider;
receiving requests from a set top box for a program recording corresponding to a program on at least one of the plurality of EPGs;
receiving the requested program recording; and
transmitting the requested program recording to the communication device
requesting the program recording.

9. The method of claim 6, comprising recording the requested program recording at the server before transmitting.

10. The method of claim 8, wherein the primary service provider chargers a subscriber a pay-per-program-recording fees.

11. The method of claim 8, wherein the program recording corresponding to the program on at least one of the plurality of EPGs is a program available among the plurality of remote network sources.

12. The method of claim 8, wherein the program recording corresponding to the program on at least one of the plurality of EPGs is a program only available from the primary service provider.

13. The method of claim 8, comprising receiving the requests from a cellular phone in communication with the set top box.

14. A network device comprising a controller programmed to:
transmit requests on a primary network for a program recording corresponding to a program on at least one of the plurality of Electronic Program Guides (EPGs), wherein the EPGs are retrieved from a plurality of network sources including a plurality of remote network sources unaffiliated with the primary network; and
receive the requested program recording.

15. The device of claim 14, wherein the controller is programmed to store the received requested program recording.

16. The device of claim 15, wherein the controller is programmed to store a program links list used for obtaining access to the program recordings corresponding to the EPGs from the plurality of network sources including the plurality of remote network sources unaffiliated with the primary network.

17. The device of claim 16, wherein the personal video receiver supports virtual storage of the program recordings available from the plurality of network sources using the program links list.

18. The device of claim 14, wherein the network device is a cellular phone.

19. The device of claim 14, wherein the network device is a set top box.

20. The storage medium of claim 1, wherein the communication device is a set top box or a personal video recorder.
